(19) United States
(12) Patent Application Publication
(10) Pub. No.: US 2010/0004348 A1
(43) Pub. Date: Jan. 7, 2010

(54) EXPANDABLE STYRENE POLYMERS AND FOAMS WITH DECREASED WATER ABSORPTION

(76) Inventors: Frank Braun, Ludwigshafen (DE); Angelika Keller, Bohl-Iggelheim (DE); Gerhard Dembeck, Bad Durkheim (DE); Jürgen von Auenmüller, Oberhausen-Rheinhausen (DE)

Correspondence Address: CONNOLLY BOVE LODGE & HUTZ LLP, 1875 EYE STREET, N.W., SUITE 1100, WASHINGTON, DC, 20006, US

(21) Appl. No.: 12/519,969

(22) PCT Filed: Dec. 17, 2007
(86) PCT No.: PCT/EP07/64035

§ 371 Date: Jun. 18, 2009

(30) Foreign Application Priority Data
Dec. 18, 2006 (EP) 06126365.3

(51) Int. Cl. C08J 9/224

(52) U.S. Cl. 521/57

(57) ABSTRACT

The present invention relates to an expandable styrene polymer which comprises athermanous particles and has been coated with a hydrophobicizing agent, which comprises from 10 to 90% by weight of at least one triester of at least one fatty acid with a polyhydric alcohol, as component A, from 5 to 70% by weight of at least one monoester of a fatty acid with a polyhydric alcohol, as component B, from 5 to 80% by weight of at least one metal salt of a fatty acid, as component C, from 5 to 50% by weight of at least one silicate, as component D, and from 0 to 30% by weight of at least one antistatic agent, as component E, and the entirety of components A to E of the hydrophobicizing agent amounts to 100% by weight, to a process for preparation of expandable styrene polymer, via coating of an expandable styrene polymer, which comprises athermanous particles, with a hydrophobicizing agent, to a foam produced from this expandable styrene polymer, and also to the use of a hydrophobicizing agent for coating of expandable styrene polymers comprising athermanous particles.

The present invention relates to an expandable styrene polymer which comprises athermanous particles and has been coated with a hydrophobicizing agent, to a process for preparation of this expandable styrene polymer, to foams that can be produced from the inventive styrene polymer, to the use of a hydrophobicizing agent for coating of expandable styrene polymer which comprises athermanous particles, and to lowering of the water absorption of a foam produced from the expandable styrene polymer, and also to the use of the inventive styrene polymer for thermal insulation, including that of machines and household devices, and as packaging material.

In many application sectors of polystyrene foams, these foams are exposed to water. The result of this can be penetration of moisture into the interior of the foam, and this is disadvantageous in numerous applications. Particularly critical applications are those such as perimeter insulation, in which good thermal insulation capability of the foams used is as important as low water absorption. Expanded polystyrene foams have been known for a long time and have proven successful in many fields. These foams are produced via foaming (prefoaming) of expandable polystyrene beads (EPS beads) impregnated with blowing agents, and subsequent fusion of the resultant foam beads to give moldings. Thermal insulation in the construction industry is a significant application sector for these foams.

Expandable polystyrene beads and foams produced from them are known from the prior art.

EP 0 915 127 A2 discloses expandable styrene polymers which comprise a homogeneous distribution of the athermanous particles and comprise a hydrophobicizing agent as coating. These expandable styrene polymers can be processed to give self-extinguishing foams whose density is ±35 g/l. The expandable styrene polymer beads have a coating of from 0.001 to 0.5% by weight of a hydrophobicizing agent. The hydrophobicizing agent has been selected from the group consisting of paraffin waxes having from 10 to 30 carbon atoms in the carbon chain, resin-like reaction products of N-methylolamine with a fatty acid derivative, polyfluoroalkyl (meth)acrylates, carboxylates of aluminum, zirconium, and hafnium in the form of aqueous solutions, and imidazolidones. That document does not disclose any specifically adjusted hydrophobicizing agent mixtures based on glycerol esters, metal stearates, and silicates.

EP 0 981 574 B1 discloses expandable styrene polymers comprising graphite particles. The amount of these graphite particles present in the expandable styrene polymer is from 0.05 to 8% by weight, with average particle size of from 1 to 50 μm, homogeneously distributed. That specification also discloses that the expandable particles can be coated with the conventional and known coating agents, and these coating agents have generally been selected from metal stearates, glycerol esters, and hydrophobic silicates. That document does not mention specific mixtures.

DE 195 41 725 C1 discloses expandable styrene bead polymers and foams produced therefrom with reduced capability for water absorption. These styrene bead polymers have a coating of a hydrophobicizing agent, which is composed of glycerol tristearate, of a hydrophobic silicate, and, if appropriate, of zinc stearate and glycerol monostearate. DE 195 41 725 A1 does not disclose the possibility of presence of athermanous particles in the expandable styrene bead polymer.

It is an object of the present invention to provide an expandable styrene polymer which can be processed to give a foam which has not only very low thermal conductivity but also very low water absorption capability. This expandable styrene polymer is intended to have little tendency toward caking during prefoaming. Another object is to provide a process for preparation of this expandable styrene polymer, and also to provide foams that can be produced from the inventive styrene polymer. These foams are intended to be suitable for thermal insulation.

This object is achieved via an expandable styrene polymer which comprises athermanous particles and has been coated with a hydrophobicizing agent, which comprises
from 10 to 90% by weight of at least one triester of at least one fatty acid with a polyhydric alcohol, as component A,
from 5 to 70% by weight of at least one monoester of a fatty acid with a polyhydric alcohol, as component B,
from 5 to 80% by weight of at least one metal salt of a fatty acid, as component C,
from 5 to 50% by weight of at least one silicate, as component D, and
from 0 to 30% by weight of at least one antistatic agent, as component E, and the entirety of components A to E of the hydrophobicizing agent amounts to 100% by weight.

The object is further achieved via a process for preparation of expandable styrene polymer via coating of an expandable styrene polymer, which comprises athermanous particles, with a hydrophobicizing agent, which comprises using the constitution defined above for the hydrophobicizing agent.

The object is also achieved via the use of a hydrophobicizing agent with the constitution defined above for coating expandable styrene polymers comprising athermanous particles, and for lowering the water absorption of a foam produced from the expandable styrene polymer.

The object is also achieved via a foam that can be produced from the inventive expandable styrene polymer.

The object is also achieved via the use of this expandable foam for thermal insulation, including that of machines and household devices, and as packaging material.

The inventive styrene polymers have a hydrophobicizing agent which comprises the four components A to D and, if appropriate, E, in an inventive combination. This inventive combination gives the expandable polymer beads very low tendency toward caking during prefoaming, thus improving their processability. Furthermore, foams produced from the expandable polymer beads absorb very little water, making them particularly suitable for applications in which they come into contact with water.

In one preferred embodiment, the inventive expandable styrene polymers are styrene homopolymers or styrene copolymers having up to 20% by weight, based on the weight of the polymers, of at least one further ethylenically unsaturated monomer, in particular alkylstyrenes, such as divinylbenzene, or a-methylstyrene, or acrylonitrile. Blends composed of polystyrene with other polymers are also possible, in particular with rubber and polyphenylene ether.

The styrene polymers can comprise the conventional and known auxiliaries and additives, such as flame retardants, nucleating agents, UV stabilizers, chain-transfer agents, blowing agents, plasticizers, and/or antioxidants.

The amount of the athermanous particles used depends on their nature and effect. The expandable styrene polymers preferably comprise from 0.05 to 8% by weight, particularly preferably from 0.1 to 6% by weight, of athermanous particles, based in each case on the styrene polymer. Athermanous particles used are preferably those selected from the group consisting of graphite, carbon black, aluminum, and mixtures thereof, preferably with average particle size in the range from 1 to 50 μm.

The average particle size of the graphite preferably used is from 1 to 50 μm, in particular from 2.5 to 12 μm, its bulk density being from 100 to 500 g/l and its specific surface area being from 5 to 20 m²/g. Natural graphite or ground synthetic graphite can be used. The amounts present of the graphite particles in the styrene polymer are preferably from 0.05 to 8% by weight, in particular from 0.1 to 6% by weight.

In one preferred embodiment of the invention, the expandable styrene polymer comprises flame retardants, in particular those based on organic bromine compounds. The organic bromine compounds are to have ≧70% by weight bromine content. This amount of flame retardants does not in any way impair the mechanical properties of the inventive molded polystyrene foams. Particularly suitable compounds are aliphatic, cycloaliphatic, and aromatic bromine compounds, such as hexabromocyclododecane, pentabromomonochlorocyclohexane, pentabromophenyl allyl ether, and mixtures thereof.

The effect of the bromine-containing flame retardants is considerably improved via addition of C—C- O—O-labile organic compounds. Examples of these flame retardant synergists are dicumyl and dicumyl peroxide. One preferred combination is composed of from 0.6 to 5% by weight of organic bromine compounds and from 0.1 to 1.0% by weight of the C—C- or O—O-labile organic compounds.

Various processes can be used for incorporation of the athermanous particles into the EPS beads. In one preferred embodiment, the athermanous particles are mixed with a melt of the styrene polymer, preferably in an extruder. The blowing agent is simultaneously metered into the melt here. It is also possible to incorporate the athermanous particles into a melt of styrene polymer comprising blowing agent, and it is advantageous here to use side fractions from a range of beads extracted by sieving from polystyrene beads prepared by suspension polymerization and comprising blowing agent. The polystyrene melt comprising blowing agent and comprising athermanous particles is extruded and comminuted to give pellets comprising blowing agent. Since in particular graphite has marked nucleating action, the material should be rapidly cooled after extrusion under pressure in order to avoid foaming. Underwater pelletization under pressure is therefore advantageous.

It is also possible to add the blowing agent in a separate step of a process to the styrene polymers which comprise athermanous particles. The pellets here are preferably impregnated in aqueous suspension with the blowing agent.

The athermanous particles can be added directly to the polymer melt. The particles added to the melt can also take the form of a concentrate in the appropriate polymer, preferably polystyrene. However, it is preferable to charge polymer pellets, in particular polystyrene pellets, and athermanous particles together to an extruder, to melt the polymer, and to mix it with the particles.

In principle, it is also possible to incorporate the athermanous particles before the suspension polymerization process is complete. They can be added here to the reaction mixture prior to suspension of the styrene monomers or during the course of the polymerization cycle, preferably during the first half thereof. The blowing agent is preferably added during the course of the polymerization reaction, but it can also be added subsequently to the styrene polymer. For stability of the suspension, it is advantageous that, at the start of the suspension polymerization reaction, there is a solution of polystyrene, or of an appropriate styrene copolymer, in styrene, or in the mixture of styrene and the appropriate comonomer(s). It is preferable here to start from a solution of polystyrene in styrene where the concentration of the polymer in the monomer is generally from 0.5 to 30% by weight, preferably from 5 to 20% by weight. Virgin polystyrene can be dissolved here in monomers, but it is advantageous to use what are known as side fractions, these being beads considered to be too large or too small which are extracted by sieving during isolation of the range of beads produced during preparation of expandable polystyrene. The diameters of these unusable side fractions are in practice greater than 2.0 mm and smaller than 0.2 mm. It is also possible to use recycled polystyrene and recycled polystyrene foam. Another possibility consists in prepolymerizing styrene in bulk to conversion of from 0.5 to 70% and suspending the prepolymer together with the athermanous particles in the aqueous phase and polymerizing to completion.

The amounts added of the blowing agent are conventional, from about 3 to 10% by weight, based on the weight of the polymer. Usual blowing agents used are aliphatic hydrocarbons having from 3 to 10, preferably from 4 to 6, carbon atoms, e.g. n-pentane, isopentane, or a mixture thereof.

In one preferred embodiment, the amount of the hydrophobicizing agent present in the inventive styrene polymer is from 0.001 to 0.5% by weight, particularly preferably from 0.01 to 0.4% by weight, in each case based on the styrene polymer.

The inventively used hydrophobicizing agent generally comprises

from 10 to 90% by weight of at least one triester of at least one fatty acid with a polyhydric alcohol, as component A,

from 5 to 70% by weight of at least one monoester of a fatty acid with a polyhydric alcohol, as component B,

from 5 to 80% by weight of at least one metal salt of a fatty acid, as component C,

from 5 to 50% by weight of at least one silicate, as component D, and

from 0 to 30% by weight of at least one antistatic agent, as component E,

where the entirety of components A to E of the hydrophobicizing agent amounts to 100% by weight.

In one preferred embodiment of the present invention, the hydrophobicizing agent comprises

from 20 to 60% by weight, particularly preferably from 25 to 50% by weight, of at least one triester of at least one fatty acid with a polyhydric alcohol, as component A,

from 5 to 50% by weight, particularly preferably from 5 to 30% by weight, of at least one monoester of a fatty acid with a polyhydric alcohol, as component B,

from 5 to 60% by weight, particularly preferably from 30 to 55% by weight, of at least one metal salt of a fatty acid, as component C, and

from 5 to 30% by weight, particularly preferably from 10 to 20% by weight, of at least one silicate, as component D,

where the entirety of components A to D of the hydrophobicizing agent amounts to 100% by weight.

In another preferred embodiment, the hydrophobicizing agent used is composed of the amounts given above of components A to D given above.

Component A:

Triester of at least one fatty acid with a polyhydric alcohol means that a polyhydric alcohol which has at least three hydroxy functions has been esterified by way of three of these hydroxy functions, in each case with a fatty acid. According to the invention, it is possible here that all three of the hydroxy functions have been esterified with molecules of three different fatty acids, or that two or three hydroxy functions have respectively been esterified with a molecule of the same fatty acid. According to the invention, it is preferable that all three of the hydroxy functions of the polyhydric alcohol have been esterified with a molecule of the same fatty acid.

Polyhydric alcohols having at least three hydroxy functions are those selected from the group consisting of glycerol, trimethylolpropane, pentaerythritol, saccharides, and mixtures thereof. Glycerol is particularly preferred.

According to the invention, it is possible to use any of the saturated and unsaturated fatty acids which have from 8 to 28, preferably from 12 to 25, carbon atoms and are known to the person skilled in the art. They can be unbranched or branched, and also aliphatic, cycloaliphatic, or aromatic. Aromatic fatty acids are less preferred. Saturated fatty acids are preferably used.

Examples of saturated fatty acids are present in the glycerol triesters used according to the invention are pelargonic acid (C₈H₁₇COOH), capric acid (C₉H₁₉COOH), undecylic acid (C₁₁H₂₁COOH), lauric acid (C₁₁H₂₃COOH), myristic acid (C₁₃H₂₇COOH), palmitic acid (C₁₅H₃₁COOH), margaric acid (C₁₆H₃₃COOH), stearic acid (C₁₇H₃₅COOH), arachic acid (C₁₉H₃₉COOH), behenic acid (C₂₁H₄₃COOH), lignoceric acid (C₂₃H₄₇COOH), ricinoleic acid (C₁₇H₃₂(OH)COOH) and cerotic acid (C₂₅H₅₁COOH). It is particularly preferable to use stearic acid. It is therefore particularly preferable to use glycerol tristearate as component A. Triesters of glycerol can be prepared by methods known to the person skilled in the art, for example via acid- or base-catalyzed reaction of the appropriate amount of fatty acid with glycerol.

Examples of unsaturated fatty acids present in the glycerol triesters used according to the invention are undecylenic acid (C₁₀H₁₉COOH), palmitoleic acid (C₁₅H₂₉COOH), oleic acid (C₁₇H₃₃COOH), elaidic acid (C₁₇H₃₃COOH), vaccenic acid (C₁₇H₃₃COOH), icosenoic acid (C₁₉H₃₉COOH), cetoleic acid (C₂₁H₄₁COOH), erucic acid (C₂₁H₄₁COOH), nervonic acid (C₂₃H₄₇COOH), linoleic acid (C₁₇H₃₁COOH), linolenic acid (C₁₇H₂₉COOH), arachidonic acid (C₁₉H₃₁COOH), timnodonic acid (C₁₉H₂₉COOH), clupanodonic acid (C₂₁H₃₃COOH), and cervonic acid (C₂₁H₃₁COOH).

Component B:

In the monoester of a fatty acid with a polyhydric alcohol, one hydroxy function of the polyhydric alcohol has been esterified with a fatty acid. The fatty acids used in component B can be the same as those mentioned for component A. Saturated fatty acids are preferably present in component B. The fatty acid present is particularly preferably stearic acid. Polyhydric alcohols which have at least two hydroxy functions can be used in component B. One of the hydroxy functions has been esterified with the fatty acid, while at least one further hydroxy function is present in free form. Suitable polyhydric alcohols are those mentioned in relation to component A. Glycerol is particularly preferably present as polyhydric alcohol in component B. In one particularly preferred embodiment, therefore, glycerol monostearate is used as component B. Monoesters of glycerol can be prepared by methods known to the person skilled in the art, for example via acid- or base-catalyzed reaction of the appropriate amount of fatty acid with glycerol.

Component C:

At least one metal salt of a fatty acid is present as component C in the inventive hydrophobicizing agent. Suitable metals are those selected from the group consisting of calcium, magnesium, aluminum, zinc, barium, and mixtures thereof. It is preferable to use a salt of the metal zinc. In relation to the preferred fatty acids, the statements relating to component A apply. It is preferable to use a saturated fatty acid and it is particularly preferable to use stearic acid. It is very particularly preferable to use zinc stearate as component C. Zinc stearate is commercially available or obtainable by way of example via reaction of stearic acid or appropriate metal stearates with suitable zinc salts.

Component D:

At least one hydrophilic or hydrophobic silicate is used as component D in the inventive hydrophobicizing agent. Suitable hydrophilic silicates are not only the precipitated silicas and silica gels prepared in solution-chemistry processes but in particular fumed silicas. In one preferred embodiment, a hydrophobic silica gel is used. Suitable hydrophobic silicates can by way of example be obtained from hydrophilic silicas via post-treatment with hydrophobicizing agents. These silicates are commercially available or obtainable by processes known to the person skilled in the art.

Component E:

An antistatic agent can be used, if appropriate, as component E. Examples of those suitable are alkylsulfonates, alkyl sulfates and alkyl phosphates, fatty alcohol ethoxylates, and quaternary ammonium compounds.

In one particularly preferred embodiment, the inventive hydrophobicizing agent comprises glycerol tristearate, glycerol monostearate, zinc stearate, and at least one silicate, in the abovementioned amounts. One particularly preferred embodiment of the present invention therefore provides an inventive styrene polymer where the hydrophobicizing agent comprises
from 20 to 60% by weight of glycerol tristearate, as component A,
from 5 to 40% by weight of glycerol monostearate, as component B,
from 5 to 60% by weight of zinc stearate, as component C, and
from 5 to 30% by weight of at least one, preferably hydrophobic silicate, as component D,
   and the entirety of components A to D of the hydrophobicizing agent amounts to 100% by weight.

The present invention also provides a process for preparation of inventive expandable styrene polymer, via coating of an expandable styrene polymer, which comprises athermanous particles, with a hydrophobicizing agent which has the abovementioned constitution. By way of example, the method disclosed in WO 06/082232 A1 can be used for coating the expandable styrene polymer. According to that document, expandable styrene polymers are obtained via the following steps: a) production of a melt of the polymer, b) mixing with a blowing agent, c) cooling of the mixture, and d) pelletizing of the resultant solid mixture. The coating of the styrene polymer then takes place in the pelletizer via coating agents which are capable of suspension, emulsification, or solution in water. The EPS pellets are preferably coated with coating agent using from 0.001 to 5% by weight, preferably from 0.01 to 0.5% by weight, particularly preferably from 0.01 to 0.4% by weight, in each case based on the solid. The amount applied of the coating agent can be adjusted for example through the concentration in the water circuit. The amounts generally used of the coating agent in the water circuit of the underwater pelletizer are in the range from 0.05 to 20% by weight, preferably in the range from 0.1 to 10% by weight, based on solids content in the water. For constant coating quality, the concentration of the coating agent in the water in the circuit should be kept constant, for example through constant feed of the coating agent as appropriate for the amount discharged over the coated EPS.

The aqueous emulsion of the hydrophobicizing agent is preferably applied to the EPS beads immediately after work-up and drying, for example in the pelletizing step.

In another preferred embodiment, the hydrophobicizing agent is applied in bulk to the EPS beads. For this, EPS beads are mixed intimately with an appropriate coating agent, for example in a drum mixer or paddle mixer.

In another preferred embodiment, the hydrophobicizing agent can also be added during the preparation of the EPS beads via polymerization of styrene and, if appropriate, of further comonomers, in aqueous suspension.

After treatment of the EPS beads with the hydrophobicizing agents, the beads are dried. Air at room temperature or at a slightly elevated temperature is usually used for this purpose, but when unfoamed beads are treated the air temperature must be sufficiently below their softening point to prevent any unintended foaming and/or blowing agent escape. The average particle size of the EPS beads is generally from 0.1 to 3 mm, in particular from 0.2 to 2.5 mm.

The inventive EPS beads can be processed to give foams whose densities are from 5 to 80 g/l, preferably from 10 to 70 g/l, and in particular from 15 to 60 g/l.

The present invention also provides a process for production of foams via preparation of expandable styrene polymers which have been coated with the inventive coating agents, via the inventive process, and foaming of these expandable styrene polymers.

The foaming of the EPS beads comprising blowing agent, to give foams, usually likewise takes place by processes known from the prior art, by first prefoaming them, using steam in open or closed prefoamers. The prefoamed beads are then fused by means of steam to give moldings or sheets, in gas-permeable molds. The average particle size of the expanded polystyrene beads is generally from 1 to 10 mm, in particular from 2 to 8 mm.

Surprisingly, the inventive treatment with the hydrophobicizing agent does not result in any kind of disadvantage in terms of the mechanical and processing properties of the styrene polymers. Nor is there any increase in demolding times.

The foams produced from the inventive expandable styrene polymers feature excellent thermal insulation. Furthermore, foams produced from the inventive EPS beads absorb only very little water. A further advantage of the inventive EPS beads is that prefoams produced from them have very little tendency toward caking. The step of removal of agglomerated particles can therefore be omitted during the process for production of prefoamed beads, and according to the invention there is no loss of prefoamed beads.

The present invention also provides foams which are produced from the inventive expandable styrene polymers.

The present invention also provides the use of a hydrophobicizing agent which has the constitution defined above for coating expandable styrene polymers comprising athermanous particles.

The present invention further provides the use of a hydrophobicizing agent which has the constitution defined above for lowering the water absorption of a foam produced from the expandable styrene polymer.

The present invention also provides the use of the inventive foam for thermal insulation, for example of buildings or of parts of buildings, known as perimeter insulation. The inventive foams can be applied here to the outer side of the parts to be insulated, or else to their inner side.

The present invention also provides the use of the inventive foam for thermal insulation of machines and of household devices, for example ovens, refrigerators, chest freezers, water heaters, or insulated flasks.

The present invention also provides the use of the inventive foam as packaging material. The foam here can be used in bead form, so that the article to be packed lies within an uncompacted bed. It is also possible to use the inventive foam to produce a one-piece product into which the article to be packed is embedded.

### EXAMPLES

### Example 1 (Inventive)

EPS beads whose diameter is from 0.5 to 0.8 mm and which comprise 3.6% by weight of graphite whose particle size is 5 μm are mixed intimately with the inventive coating agent in a paddle mixer. The total amount of hydrophobicizing agent in relation to the EPS beads is 0.3% by weight. The constitution of the coating agent is as follows:
30% by weight of glycerol tristearate, as component A,
10% by weight of glycerol monostearate, as component B,
50% by weight of zinc stearate, as component C, and
10% by weight of hydrophobic silicate, as component D.

The hydrophobic silicate used is a reaction product of dichlorodimethylsilane and silicon dioxide.

The coated EPS beads are expanded in a continuous prefoamer. Agglomerated, i.e. caked, particles are removed by sieving. The proportion by weight of caked particles is 0.1%.

After sieving, the resultant foam beads are fused to give sheet-like moldings whose density is 30 g/l. Water absorption is tested on moldings cut-to-size from these after underwater storage to EN 12087. Water absorption after 28 days is 0.44% by volume.

### Comparative Example 1

Production, coating, processing, and testing is carried out as in example 1.

The coating agent used comprises a mixture composed of
90% by weight of glycerol tristearate, as component A,
5 by weight of glycerol monostearate, as component B, and
5% by weight of zinc stearate, as component C.

No silicate is present in the comparative mixture.

The proportion by weight of caked beads which have to be removed after prefoaming is 11.2% by weight. Water absorption after 28 days is 0.35% by volume, measured to EN 12087.

### Comparative Example 2

25 kg of EPS (bead size from 0.4 to 0.7 mm, pentane content 6.1%) comprising no athermanous particles are mixed intimately for 10 min at 25° C. in a paddle mixer whose volume is 40 l with a coating agent which comprises, in each case based on the EPS,
0.25% by weight of glycerol monostearate (corresponding to 50% by weight, based on the mixture),
0.13% by weight of zinc stearate (corresponding to 26% by weight, based on the mixture), and
0.12% by weight of fine-particle silica (Degussa) (corresponding to 24% by 40 weight, based on the mixture).

This coating agent comprises no glycerol tristearate. The coated beads are then prefoamed in a foaming box (System Rauscher) at atmospheric pressure and processed after 12 hours to give sheet-like moldings (density 20 kg/m³).

The following method is used to measure water resistance: A tube whose diameter is 100 mm is adhesive-bonded to a foam sheet whose thickness is 100 mm, and water is charged to the tube to give a column of height 100 mm. After 24 hours, the underside of the foam sheet is checked for discharge of water. Lowering of the water meniscus is measured, in mm of water column. Prior to the test, the foam sheet is conditioned at 60° C. in a drying cabinet for 24 hours. Silicone rubber is then used for adhesive-bonding of the tubes.

The foam sheet according to comparative example 2 exhibits inadequate water resistance: 28 mm. Water absorption of the foam sheet is also measured to DIN 53433. Water absorption is 5.8% by volume.

### Comparative Example 3

Conduct of the example corresponds to comparative example 2. The constitution of the coating composition used, in each case based on the EPS, is
0.32% by weight of glycerol tristearate (corresponding to 64% by weight, based on the mixture),
0.1% by weight of fine-particle silica (corresponding to 20% by weight, based on the mixture), and
0.08% by weight of zinc stearate (corresponding to 16% by weight, based on the mixture).

This coating agent comprises no glycerol monostearate. The resultant foam sheets are not water-resistant.

The inventive example and the three comparative examples show that only the inventive combination of components A to D prevents caking, during prefoaming, of the EPS beads produced therewith, while giving foams produced therefrom particularly low water absorption.

1. An expandable styrene polymer which comprises athermanous particles and has been coated with a hydrophobicizing agent, which comprises
from 10 to 90% by weight of at least one triester of at least one fatty acid with a polyhydric alcohol, as component A,
from 5 to 70% by weight of at least one monoester of a fatty acid with a polyhydric alcohol, as component B,
from 30 to 55% by weight of at least one metal salt of a fatty acid, as component C, and
from 5 to 50% by weight of at least one silicate, as component D,
where the entirety of components A to D of the hydrophobicizing agent amounts to 100% by weight.

2. The styrene polymer according to claim 1, wherein the silicate is a hydrophobic silicate.

3. The styrene polymer according to claim 1, wherein the amount present of the athermanous particles is from 0.05 to 8% by weight, based on the styrene polymer.

4. The styrene polymer according to claim 1, wherein the amount present of the hydrophobicizing agent is from 0.001 to 0.5% by weight, based on the styrene polymer.

5. The styrene polymer according to claim 1, which is a styrene homopolymer or a styrene copolymer having up to 20% by weight, based on the weight of the polymer, of at least one further ethylenically unsaturated monomer.

6. The styrene polymer according to claim 1, wherein the athermanous particles have been selected from the group consisting of graphite, carbon black, aluminum, and mixtures thereof

7. The styrene polymer according to claim 1, wherein the hydrophobicizing agent comprises
from 20 to 60% by weight of glycerol tristearate, as component A,
from 5 to 50% by weight of glycerol monostearate, as component B,
from 30 to 55% by weight of zinc stearate, as component C, and
from 5 to 30% by weight of at least one silicate, as component D,
where the entirety of components A to D of the hydrophobicizing agent amounts to 100% by weight.

8. A process for preparation of expandable styrene polymer, via coating of an expandable styrene polymer, which comprises athermanous particles, with a hydrophobicizing agent, which comprises using the constitution defined in claim 1 for the hydrophobicizing agent.

9. A foam, produced from the expandable styrene polymer according to claim 1.

10. A process for production of foams according to claim 9 via preparation of expandable styrene polymers, by a process for preparation of expandable styrene, via coating of an expandable styrene polymer, which comprises athermanous particles, with a hydrophobicizing agent, which comprises using
from 10 to 90% by weight of at least one triester of at least one fatty acid with a polyhydric alcohol, as component A,
from 5 to 70% by weight of at least one monoester of a fatty acid with a polyhydric alcohol, as component B,
from 30 to 55% by weight of at least one metal salt of a fatty acid, as component C, and
from 5 to 50% by weight of at least one silicate as component D, and
where the entirety of components A to E of the hydrophobicizing agent amounts to 100% by weight for the hydrophobicizing agent and foaming of these expandable styrene polymers.

11. The method of using a hydrophobicizing agent which has the constitution defined in claim 1 for coating of expandable styrene polymers comprising athermanous particles.

12. The method of using a hydrophobicizing agent which has the constitution defined in claim 1 for lowering the water absorption of a foam produced from expandable styrene polymer.

13. The method of using a foam according to claim 9 for thermal insulation.

14. The method of using a foam according to claim 9 for thermal insulation of machines and of household devices.

15. The method of using a foam according to claim 9 as packaging material.

16. The styrene polymer according to claim 2, wherein the amount present of the athermanous particles is from 0.05 to 8% by weight, based on the styrene polymer.

17. The styrene polymer according to claim 2, wherein the amount present of the hydrophobicizing agent is from 0.001 to 0.5% by weight, based on the styrene polymer.

18. The styrene polymer according to claim 3, wherein the amount present of the hydrophobicizing agent is from 0.001 to 0.5% by weight, based on the styrene polymer.

19. The styrene polymer according to claim 2, which is a styrene homopolymer or a styrene copolymer having up to 20% by weight, based on the weight of the polymer, of at least one further ethylenically unsaturated monomer.

20. The styrene polymer according to claim 3, which is a styrene homopolymer or a styrene copolymer having up to 20% by weight, based on the weight of the polymer, of at least one further ethylenically unsaturated monomer.
